(19) United States
(12) Patent Application Publication
(10) Pub. No.: US 2024/0150627 A1
(43) Pub. Date: May 9, 2024

(54) SELF-HEALING MATERIAL

(71) Applicant: SONY GROUP CORPORATION, TOKYO (JP)

(72) Inventors: MASAHIKO MITSUBOSHI, TOKYO (JP); MOTOHISA INADU, TOKYO (JP); TAKAHIRO TAKI, TOKYO (JP)

(21) Appl. No.: 18/549,103

(22) PCT Filed: Jan. 11, 2022
(86) PCT No.: PCT/JP2022/000514

§ 371 Date: Sep. 5, 2023

(30) Foreign Application Priority Data
Mar. 12, 2021 (JP) 2021-039887

(51) Int. Cl. C09J 9/00; C09J 133/08; C09J 163/00

(52) U.S. Cl. CPC C09J 9/00; C09J 133/08; C09J 163/00

(57) ABSTRACT

To provide a self-healing material having excellent productivity and self-healing properties. A self-healing material according to the present technology includes: a base material; a first capsule; and a second capsule. The first capsule includes a first outer shell having flexibility and a first fluid encapsulated in the first outer shell, and is mixed with the base material. The second capsule includes a second outer shell having flexibility and a second fluid that is encapsulated in the second outer shell and to be cured by contact with the first material, and is mixed with the base material.

### TECHNICAL FIELD

The present technology relates to a self-healing material capable of self-healing cracks.

### BACKGROUND ART

Adhesives are often used for joining parts, for example. However, minute cracks occur in the adhesive in some cases, for example, due to temperature shock, in a case where a reliability test such as a drop test is performed, or in a case where the adhesive is actually used in the market for a long period of time. The minute cracks gradually grow, which finally lead to semi-destruction or complete destruction of the joined portion and may impair the function of the product.

Adhesion portions are designed and adhesives are selected so that such a phenomenon does not occur, but market and customer demands are increasing year by year and there are cases where it is difficult to guarantee with existing adhesives. Further, with the acceleration of automated driving and the expansion of 5G (5th Generation Mobile Communication System), it is easy to predict that the number of devices installed outdoors and in automobiles will rapidly increase and existing adhesives and adhesion technologies will not be able to meet market demands.

Meanwhile, in recent years, a technology capable of self-healing cracks when cracks occur in adhesives has also been developed. For example, Patent Literature 1 discloses a self-healing agent in which a healing agent encapsulated in a base adhesive and a catalyst that cures the healing agent are combined. In this technology, when a crack occurs in the base adhesive, the capsule is ruptured, the healing agent and the curing agent are mixed, and thus, the healing agent is cured, thereby repairing the crack.

### CITATION LIST

### Patent Literature

Patent Literature 1: Japanese Patent Application Laid-open No. 2017-218519

### DISCLOSURE OF INVENTION

### Technical Problem

However, in the technology described in Patent Literature 1, since a curing agent is added to the base adhesive, it is necessary to select a base adhesive of a system completely different from the healing agent in order to prevent the adhesive from being unintentionally cured or thickened before use (when liquid), which limits the range of application. Further, when a curing agent is added to the base adhesive, there is also a possibility that adverse effects such as shortening of the service life occur. Further, in order to sufficiently mix the healing agent and the curing agent when a crack occurs in the adhesive, it is necessary to disperse a large amount of the capsules and the curing agents uniformly in the base adhesive.

In view of the circumstances as described above, it is an object of the present technology to provide a self-healing material having excellent productivity and self-healing properties.

### Solution to Problem

In order to achieve the above-mentioned object, a self-healing material according to the present technology includes: a base material; a first capsule; and a second capsule.

The first capsule includes a first outer shell having flexibility and a first fluid encapsulated in the first outer shell, and is mixed with the base material.

The second capsule includes a second outer shell having flexibility and a second fluid that is encapsulated in the second outer shell and to be cured by contact with the first material, and is mixed with the base material.

The first outer shell and the second outer shell may be formed of a material having an elastic modulus of 20 MPa or more and 85 MPa or less.

The first outer shell and the second outer shell may be formed of gelatin.

The first outer shell and the second outer shell may be formed of melamine.

The first fluid may be an SGA (Second Generation Acrylic adhesive) main agent, and the second fluid may be an SGA curing agent.

The base material may be joined to the first outer shell and the second outer shell.

The first outer shell and the second outer shell may be formed of gelatin, and the base material may be an epoxy adhesive or an acrylic adhesive.

The first outer shell and the second outer shell may be formed of melamine, and the base material may be an epoxy adhesive or an acrylic adhesive.

The base material may be a material having a Shore D hardness of 60 or more.

A total mixing amount of the first capsule and the second capsule with the base material may be 5% (V/V) or more and 20% (V/V) or less.

### BRIEF DESCRIPTION OF DRAWINGS

FIG. 1 is a schematic diagram of a self-healing material according to an embodiment of the present technology.

FIG. 2 is a cross-sectional view of a first capsule included in the self-healing material.

FIG. 3 is a cross-sectional view of a second capsule included in the self-healing material.

FIG. 4 is a schematic diagram showing a crack occurred in the self-healing material.

FIG. 5 is an enlarged view of FIG. 4.

FIG. 6 is a schematic diagram of the self-healing material in which the crack has been healed.

FIG. 7 is a schematic diagram showing an aspect in which a self-healing material according to an embodiment of the present technology is used as a filler.

FIG. 8 is a schematic diagram showing an aspect in which the self-healing material is used as a filler.

FIG. 9 is an enlarged view of FIG. 8.

FIG. 10 is a schematic diagram showing a crack occurred in the self-healing material.

FIG. 11 is a schematic diagram of the self-healing material in which the crack has been healed.

FIG. 12 is a schematic diagram showing an experimental method according to an Example.

FIG. 13 is a schematic diagram showing an experimental method according to the Example.

FIG. 14 is a schematic diagram showing an experimental result according to the Example.

FIG. 15 is a schematic diagram showing an experimental method according to a Comparative Example.

FIG. 16 is a schematic diagram showing an experimental result according to the Comparative Example.

FIG. 17 is a schematic diagram showing an experimental method according to the Example.

FIG. 18 is a schematic diagram showing an experimental method according to the Example.

FIG. 19 is a graph showing experimental results according to the Example and the Comparative Example.

FIG. 20 is a schematic diagram showing an experimental result according to the Comparative Example.

FIG. 21 is a schematic diagram showing an experimental result according to the Example.

### MODE(S) FOR CARRYING OUT THE INVENTION

A self-healing material according to an embodiment of the present technology will be described. The self-healing material according to this embodiment can be used as an adhesive.

[Configuration of Self-Healing Material]

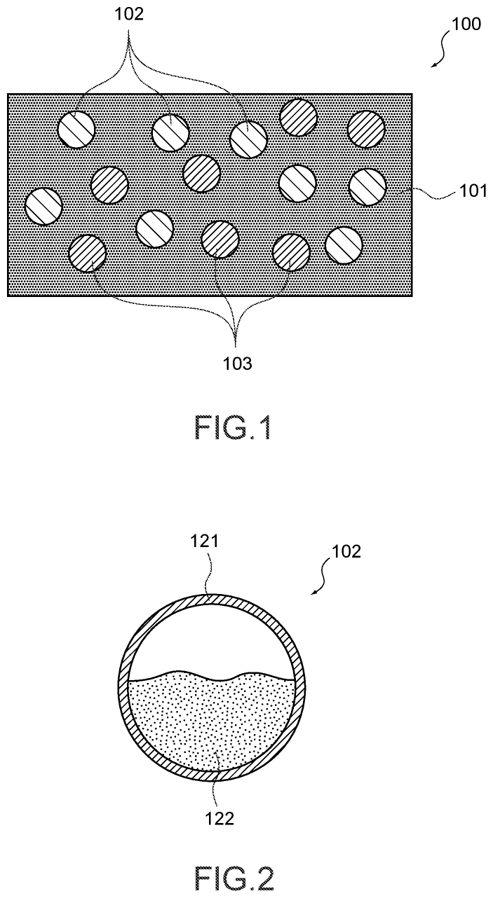

FIG. 1 is a schematic diagram of a self-healing material 100 according to this embodiment. As shown in the figure, the self-healing material 100 includes a base material 101, a first capsule 102, and a second capsule 103.

The base material 101 is a curable material having fluidity. The base material 101 can be curable by heating, ultraviolet irradiation, mixing with a curing agent, or the like.

The first capsule 102 is mixed with the base material 101. FIG. 2 is a schematic diagram showing a configuration of the first capsule 102. As shown in the figure, the first capsule 102 includes a first outer shell 121 and a first fluid 122. The first outer shell 121 is formed of a material having flexibility and is a shell that is elastically deformable. The first capsule 102 can be compressed to, for example, approximately half the capsule diameter and deformable to some extended in the tension direction. The first outer shell 121 can be a spherical shell but may be a shell having another shape. The material of the first outer shell 121 is suitable a material having an elastic modulus of 20 MPa or more and 85 MPa or less. The first fluid 122 is a fluid encapsulated in the first outer shell 121.

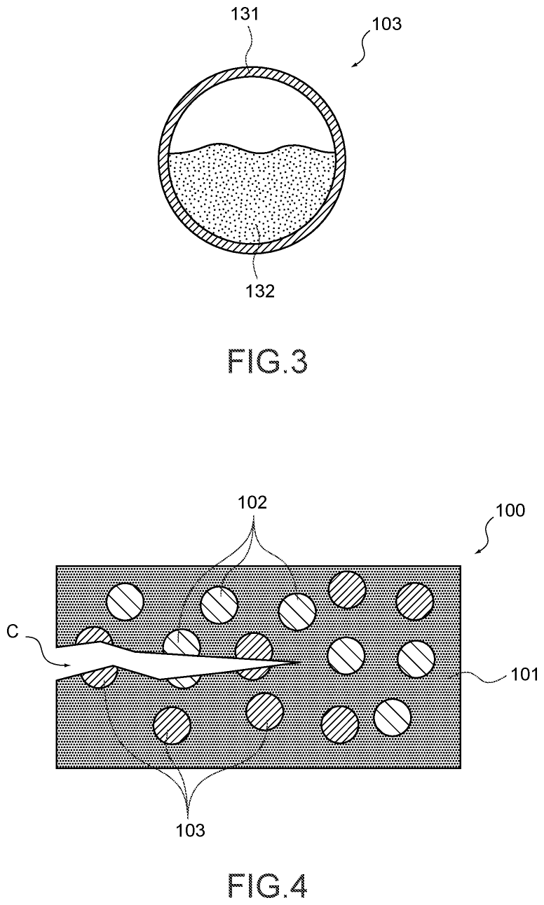

The second capsule 103 is mixed with the base material 101. FIG. 3 is a schematic diagram showing a configuration of the second capsule 103. As shown in the figure, the second capsule 103 includes a second outer shell 131 and a second fluid 132. The second outer shell 131 is formed of a material having flexibility and is a shell that is elastically deformable. The second capsule 103 can be compressed to, for example, approximately half the capsule diameter and deformable to some extended in the tension direction. The second outer shell 131 can be a spherical shell but may be a shell having another shape. The material of the second outer shell 131 is suitably a material having an elastic modulus of 20 MPa or more and 85 MPa or less. The second fluid 132 is a fluid encapsulated in the second outer shell 131.

[Regarding Material of First Outer Shell and Second Outer Shell]

The first outer shell 121 and the second outer shell 131 are formed of a material having an elastic modulus of 20 MPa or more and 85 MPa or less as described above, and can specifically be formed of gelatin (elastic modulus of 24 MPa) or melamine (elastic modulus of 84 MPa). Note that the gelatin is more suitably heat-resistant gelatin on which heat-resistant treatment has been performed.

The following [Table 1] is a table showing the possible particle size (capsule diameter) range, film strength, and airtightness in the case where the first outer shell 121 and the second outer shell 131 are formed of gelatin or melamine. The materials of the first outer shell 121 and the second outer shell 131 can be selected on the basis of the properties as shown in [Table 1]. Note that the materials of the first outer shell 121 and the second outer shell 131 may be the same or different from each other.

TABLE 1

| Outer shell | Possible particle | | Film | |
|---|---|---|---|---|
| material | size range | | strength | Airtightness |
| Gelatin | 70~2,000 | μm | Strong | Low |
| Melamine | 1~50 | μm | Weak | high |

[Regarding First Fluid and Second Fluid]

The first fluid 122 and the second fluid 132 are cured by contact with each other. Specifically, the first fluid 122 can be an SGA (Second Generation Acrylic adhesive) main agent and the second fluid 122 can be an SGA curing agent. The SGA is suitable because the curable mixing ratio of the SGA main agent and the SGA curing agent is as wide as 1:9 to 9:1.

In addition, the first fluid 122 and the second fluid 132 can be formed of a material that is cured by contact with each other. Specifically, the first fluid 122 can be a two-component epoxy main agent, and the second fluid 132 can be a two-component epoxy curing agent. Further, the first fluid 122 may be a metal anaerobic adhesive and the second fluid 132 may be a metal complex (primer). The first fluid 122 may be an instant adhesive and the second fluid 132 may be water. Further, the first fluid 122 may be a moisture-curable silicone and the second fluid 132 may be water.

[Regarding Base Material]

The base material 101 can be a curable material having fluidity as described. Specifically, the base material 101 can be an organic adhesive, for example, an epoxy adhesive or an acrylic adhesive. The base material 101 is suitably a material having a Shore D hardness of 60 or more when cured. This is because cracks described below do not occur in the case where the Shore D hardness is less than 60.

As for the relationship between the first outer shell 121 and the second outer shell 131 and the base material 101, the base material 101 is suitably a material that can be joined to the first outer shell 121 and the second outer shell 131. Specifically, in the case where the first outer shell 121 and the second outer shell 131 are formed of gelatin or melamine, by forming the base material 101 of an organic adhesive such as an epoxy adhesive and an acrylic adhesive, a chemical bond can be generated between the base material 101 and the first outer shell 121 and the second outer shell 131 to strongly join the first outer shell 121 and the second outer shell 131 and the base material 101 together. In addition, as the base material 101, a material that can be joined to the first outer shell 121 and the second outer shell 131 can be selected in accordance with the materials thereof.

[Action of Self-Healing Material]

An action of the self-healing material 100 will be described. The self-healing material 100 is applied to an object to be adhered while the base material 101 has fluidity. When the base material 101 is cured due to the lapse of time, heating, ultraviolet irradiation, or the like, the self-healing material 100 adheres to the object to be adhered.

Here, when the self-healing material 100 is repeatedly expanded and contracted due to temperature changes or deformed by external stress, cracks occur in the self-healing material 100 in some cases. FIG. 4 is a schematic diagram showing the self-healing material 100 in which a crack C has occurred. As the crack C occurs in the self-healing material 100, the first capsule 102 and the second capsule 103 facing the crack C are pulled by the base material 101 and ruptured as shown in FIG. 4.

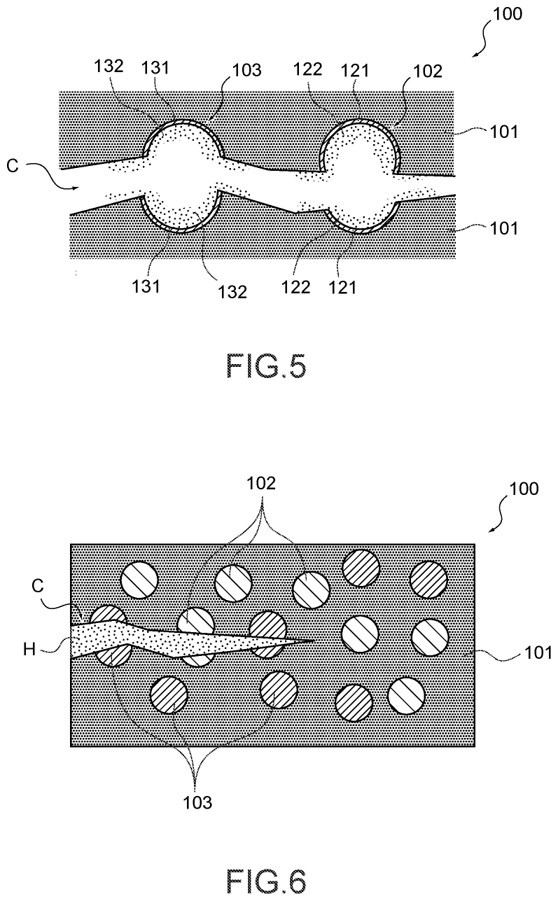

FIG. 5 is an enlarged view of FIG. 4. As shown in FIG. 5, in the ruptured first capsule 102, the first outer shell 121 is cleaved and the first fluid 122 flows out into the crack C from the first outer shell 121. Further, as shown in FIG. 5, in the ruptured second capsule 103, the second outer shell 131 is cleaved and the second fluid 132 flows out into the crack C from the second outer shell 131. The first fluid 122 and the second fluid 132 are cured by contact with each other to from a cured product in the crack C. FIG. 6 is a schematic diagram showing a cured product H formed in the crack C. As shown in the figure, the crack C is filled with the cured product H and healed thereby.

In this way, in the self-healing material 100, even if a crack has occurred in the self-healing material 100, the crack is filled with a cured product formed by the first fluid 122 and the second fluid 132 and healed by the cured product. Even if another new crack is formed in the self-healing material 100, the crack is filled with a cured product and healed by the cured product, similarly.

[Effects of Self-Healing Material]

In the self-healing material 100, the first capsule 102 includes the first outer shell 121 having flexibility and the second capsule 103 includes the second outer shell 131 having flexibility, as described above. As a result, even if stress is applied to the first capsule 102 and the second capsule 103 during mix stirring when the self-healing material 100 is produced or during application to an object to be adhered, the first capsule 102 and the second capsule 103 are deformed following the stress and are not destructed.

If the first outer shell 121 and the second outer shell 131 are formed of a brittle material such as glass and ceramic, there is a possibility that they are broken during mix stirring or application and the first fluid 132 and the second fluid 132 flow out. In this case, the first fluid 132 and the second fluid 132 are absorbed into the base material 101 and cannot perform healing when a crack occurs. Meanwhile, in the case where the first outer shell 121 and the second outer shell 131 have flexibility, the first fluid 122 and the second fluid 122 are prevented from flowing out when no crack occurs, and healing can be performed by a cured product when a crack occurs. In other words, there is no need to consider breakage of the first capsule 102 and the second capsule 103 during mix stirring and application, which facilitates handling.

Further, in the self-healing material 100, the base material 101 can be an organic adhesive, the first outer shell 121 and the second outer shell 131 can be formed of gelatin, melamine, or the like, and the base material 101 can be joined to the first outer shell 121 and the second outer shell 131. As a result, when a crack has occurred in the base material 101, the first capsule 102 and the second capsule 103 facing the crack are pulled by the base material 101 and reliably ruptured (see Example).

If the first outer shell 121 and the second outer shell 131 are formed of glass or the like, there is a possibility that the first capsule 102 and the second capsule 103 are not broken even when a crack occurs in the base material 101, and the crack cannot be healed. Meanwhile, by joining base material 101 to the first outer shell 121 and the second outer shell 131, the first capsule 102 and the second capsule 103 can be reliably ruptured by cracks. Further, by joining the base material 101 to the first outer shell 121 and the second outer shell 131, it is possible to improve the strength of the self-healing material 100 even in a state in which no crack occurs.

Further, as the first fluid 122 and the second fluid 132, an SGA (Second Generation Acrylic adhesive) main agent and an SGA curing agent can be used. Since the SGA has a wide curable mixing ratio of the SGA main agent and the SGA curing agent, which is 1:9 to 9:1, the first fluid 122 and the second fluid 132 can be entirely cured by contact with each other even if they are not sufficiently mixed. In the case where the first fluid 122 and the second fluid 132 are fluids having a predetermined mixing ratio for curing, high accuracy is required for the mixing ratio of the first capsule 102 and the second capsule 103 and the dispersion in the base material 101 in order to reliably heal cracks. Meanwhile, by using an SGA main agent and an SGA curing agent as the first fluid 122 and the second fluid 132, cracks can be reliably healed even if the mixing ratio of the first capsule 102 and the second capsule 103 and the distribution are not highly accurate.

[Regarding Mixing Amount of First Capsule and Second Capsule]

Although the mixing amount of the first capsule 102 and the second capsule 103 with the base material 101 is not particularly limited, it is suitable to mix the first capsule 102 and the second capsule 103 with the base material 101 at a ratio of 5% (V/V) (volume percent concentration, the same applied hereinafter) or more and 20% (V/V) or less, and more favorably 15% (V/V) or more and 20% (V/V) or less, in order to reliably healing minute cracks without deteriorating the properties of the base material 101 as an adhesive as much as possible. Further, the first capsule 102 and the second capsule 103 may be mixed at a ratio of 20% (V/V) or more in the case where the properties of the base material 101 are not affected or the affection is negligible.

[Regarding Particle Size of First Capsule and Second Capsule]

The particle size (capsule diameter) of each of the first capsule 102 and the second capsule 103 is suitably selected in accordance with the expected size of cracks. A capsule having a large particle size can be used in the case where the expected size of cracks is large, and a capsule having a small particle size can be used in the case where the expected size of cracks is small. Specifically, the particle size of each of the first capsule 102 and the second capsule 103 is suitably 2 to 10 times, more suitably 3 to 5 times, the expected size (width) of cracks.

[Regarding Use as Filler]

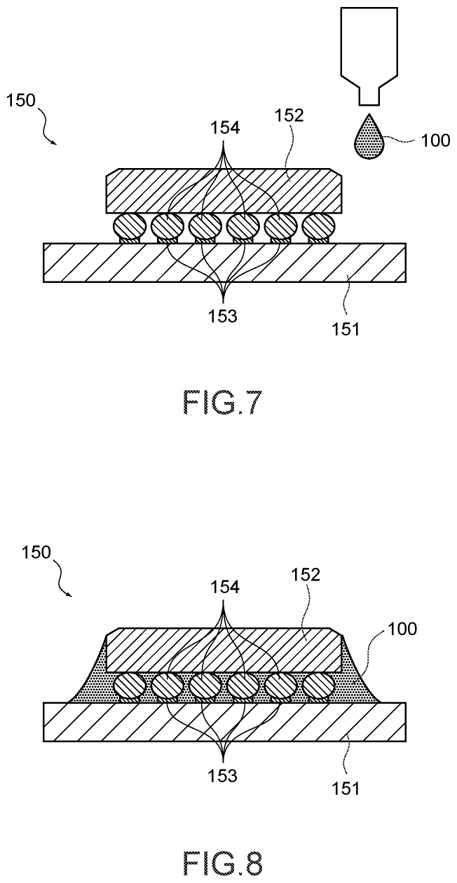

The self-healing material 100 can be used as a filler as well as an adhesive. FIG. 7 and FIG. 8 are each a schematic diagram of a mounting structure 150 using the self-healing material 100 as a filler. As shown in FIG. 7, the mounting structure 150 includes a substrate 151 and a part 152. Electrodes 153 are provided on the substrate 151, and the part 152 is joined to the electrodes 153 by solder balls 154. A gap between the substrate 151 and the part 152 is, for example, 100 μm wide. The part 152 is, for example, a BGA (ball grid array) or a CSP (chip size package).

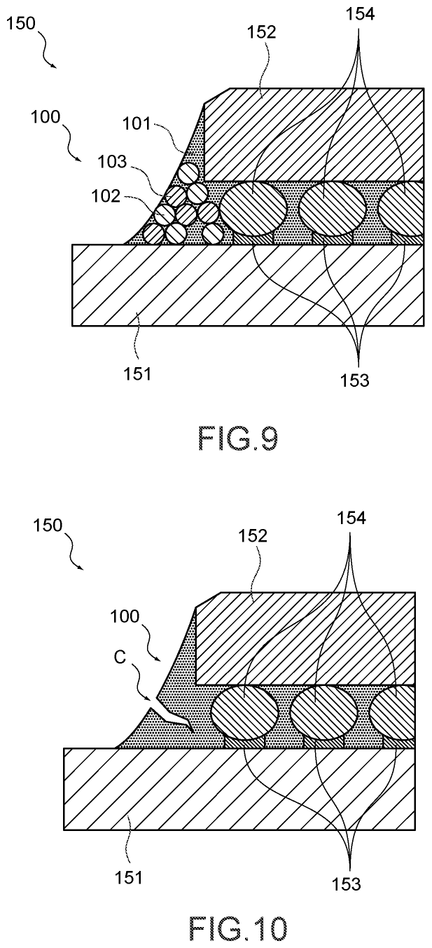

After mounting the part 152 on the substrate 151, the self-healing material 100 is supplied to the periphery of the part 152 as shown in FIG. 7, and thus, the gap between the substrate 151 and the part 152 can be filled with the self-healing material 100 as shown in FIG. 8. The self-healing material 100 functions as an underfill that prevents the solder balls 154 from being damages due to impacts such as dropping and cold and heat. FIG. 9 is an enlarged view of FIG. 8. As shown in the figure, the first capsule 102 and the second capsule 103 are prevented from flowing directly under the part 152 by the solder balls 154.

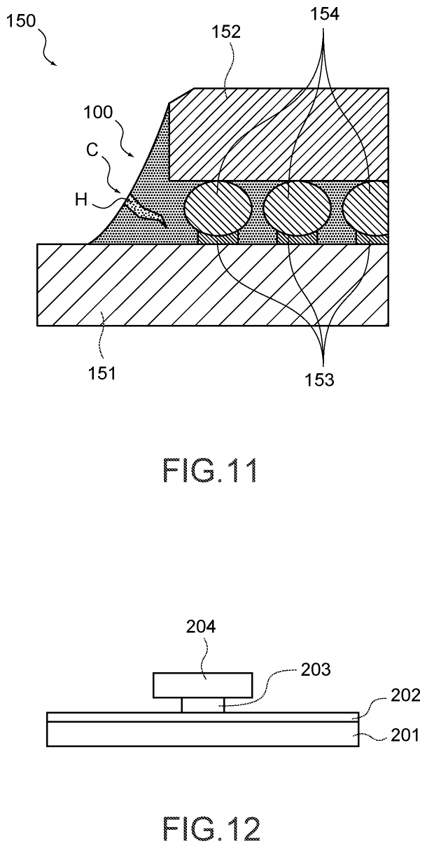

FIG. 10 and FIG. 11 are each a schematic diagram showing healing of a crack by the self-healing material 100. When the crack C occurs in the base material 101 as shown in FIG. 10, a curing agent H is formed by the ruptured first capsule 102 and the ruptured second capsule 103 to heal the crack C as shown in FIG. 11. This prevents the self-healing material 100 from being further damaged and allows the self-healing material 100 to maintain the function as an underfill. Note that the particle size of each of the first capsule 102 and the second capsule 103 may be adjusted to cause the first capsule 102 and the second capsule 103 to flow directly below the part 152 together with the base material 101.

The self-healing material 100 can be used an underfill in fields such as mobile devices, outdoor devices, and medical devices (sterilized products). Specifically, the self-healing material 100 can be used for commercial camcorders, mobile phones, medical related equipment, portable audio devices, memory cards, steel plates for automobiles, traffic infrastructure, and the like.

### Example

[Study on Cleavage of First Outer Shell and Second Outer Shell]

Experiments were conducted to verify whether or not a first outer shell and a second outer shell would be cleaved when a crack occurred in a base material of the self-healing material according to the present technology.

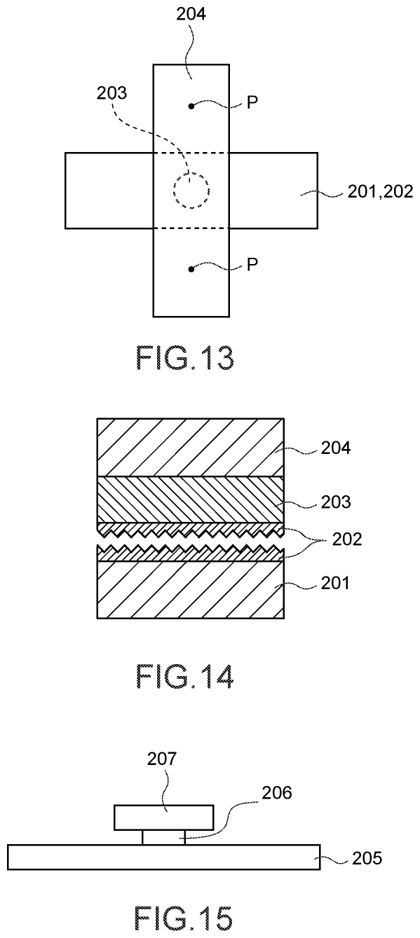

FIG. 12 and FIG. 13 are each a schematic diagram showing an experimental method. As shown in FIG. 12 and FIG. 13, gelatin 202 was applied onto a first slide glass 201. The thickness of the gelatin 202 was set to 100 μm. Further, a prescribed amount of adhesive 203 was applied onto the gelatin 202, and the first slide glass 201 and a second slide glass 204 were bonded with the adhesive 203. The thickness of the adhesive 203 was the thickness when crushed by the own weight (approximately 5 g) of the second slide glass 204. An epoxy adhesive or an acrylic adhesive was used as the adhesive 203.

After the adhesive 203 was cured, a force (50 mm/min) was applied to force points P so as to separate the first slide glass 201 and the second slide glass 204 from each other by a force gauge (manufactured by IMADA Co., Ltd.). FIG. 14 is a schematic diagram showing an experimental result. When a predetermined force was applied, the gelatin 202 was destroyed (cohesive failure) and the first slide glass 201 and the second slide glass 204 were separated from each other as shown in the figure.

From this result, it can be seen that in the case where the base material is an epoxy adhesive or an acrylic adhesive and the first outer shell and the second outer shell are formed of gelatin, the base material and the first outer shell and the second outer shell are firmly joined together and the first outer shell and the second outer shell are cleaved when cracks occur.

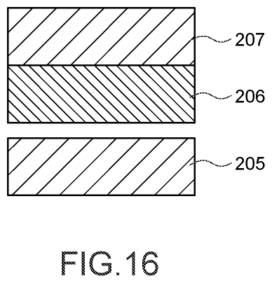

Further, for comparison, as shown in FIG. 15, a prescribed amount of adhesive 206 was applied onto the first slide glass 205 to bond the first slide glass 205 and a second slide glass 207 together. The thickness of the adhesive 206 was the thickness when crushed by the own weight (approximately 5 g) of the second slide glass 207. An epoxy adhesive or an acrylic adhesive was used as the adhesive 206. After the adhesive 206 was cured, a force was applied so as to separate the first slide glass 205 and the second slide glass 207 from each other under the same conditions by the force gauge. FIG. 16 is a schematic diagram showing an experimental result. When a predetermined force was applied, the interface between the first slide glass 205 and the adhesive 206 was peeled off as shown in the figure.

From this result, it can be seen that in the case where the base material is an epoxy adhesive or an acrylic adhesive and the first outer shell and the second outer shell are formed of glass, the interface between the first outer shell and the second outer shell and the base material is peeled off and the first outer shell and the second outer shell are not cleaved even if cracks occur.

The following [Table 2] is a table showing measurement results. As shown in [Table 2], as a result of three times of measurement, the gelatin 202 caused cohesive failure in a sample (VS. gelatin) to which the gelatin 202 was applied, and peeling occurred at the interface of the first slide glass 205 in a sample (VS. glass) to which the gelatin 202 was not applied. From the above, it can be said that by firmly joining a base material and a first outer shell and a second outer shell together in accordance with the types of materials of the base material and the first outer shell and the second outer shell, the first outer shell and the second outer shell can be reliably cleaved when cracks occur.

TABLE 2

| | Epoxy adhesive | | Acrylic adhesive | |
|---|---|---|---|---|
| Sample | VS. gelatin | VS. glass | VS. gelatin | VS. glass |
| No. | Mode | Mode | Mode | Mode |
| 1 | Cohesive | Interface | Cohesive | Interface |
| | failure | peeling | failure | peeling |
| 2 | Cohesive | Interface | Cohesive | Interface |
| | failure | peeling | failure | peeling |
| 3 | Cohesive | Interface | Cohesive | Interface |
| | failure | peeling | failure | peeling |

[Study on Healing]

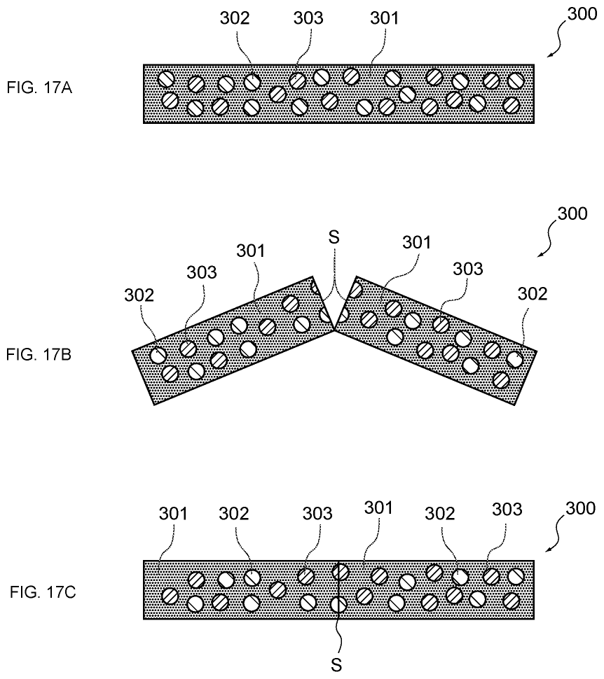

A test piece formed of the self-healing material according to the present technology was prepared, and an experiment in which the self-healing material was ruptured and then self-healed was conducted. FIG. 17 is a schematic diagram showing this experiment. As shown in Part (a) of FIG. 17, a test piece 300 was prepared. The test piece 300 includes a base material 301, a first capsule 302, and a second capsule 303, and the base material 301 is cured. An acrylic adhesive was used as the base material 301. The first capsule 302 was a capsule that includes an outer shell formed of gelatin and an SGA main agent encapsulated in the outer shell, and the second capsule 303 was a capsule that includes an outer shell formed of gelatin and an SGA curing agent encapsulated in the outer shell.

When the test piece 300 was ruptured as shown in Part (b) of FIG. 17 and a rupture surface S was observed, the broken first capsule 302 and the broken second capsule 303 were observed. When the rupture surfaces S were brought together as shown in Part (c) of FIG. 17 and pressed for a certain period of time, the test piece 300 was healed to the state before the rupture as shown in Part (a) of FIG. 17. This is because the SGA main agent flowed out of the first capsule 302 and the SGA curing agent flowed out of the second capsule 303 reacted and were cured.

[Study on Crack Length]

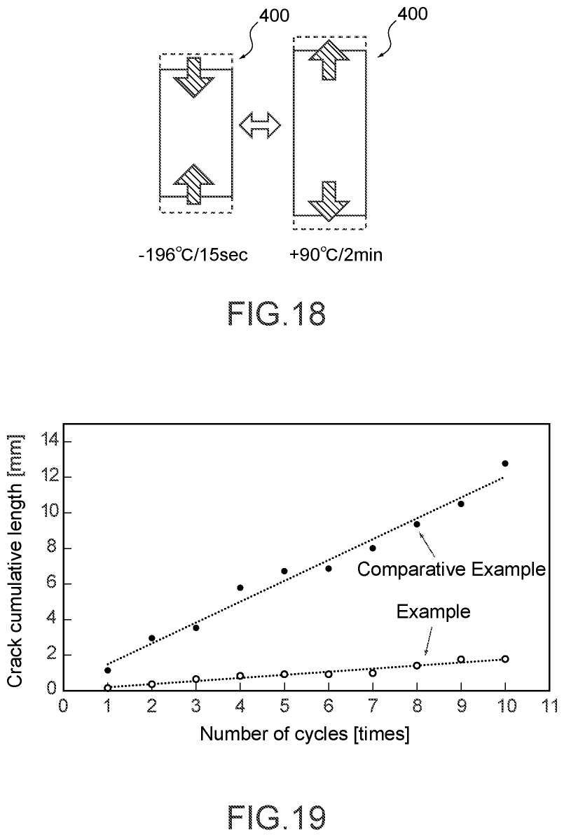

A test piece formed of the self-healing material according to the present technology was prepared and an experiment in which temperature stress was applied thereto was conducted. FIG. 18 is a schematic diagram showing this experiment. As shown in FIG. 18, a test piece 400 was alternately cooled and heated to shrink and expand. The cooling was −196° C. for 15 seconds, the heating was +90° C. for 2 minutes, and the temperature difference was 286° C. The test piece 400 has the same configuration as that of the test piece 300 described above. Further, a test piece 500 formed of only a base material was prepared as a Comparative Example, and similar temperature stress was applied thereto. Taking cooling and heating as one cycle, the cumulative length (average of three cracks) of cracks was measured as the number of cycles increased.

FIG. 19 is a graph showing an experimental result. As shown in the figure, in the case of the Example (test piece 400), the cumulative length of cracks was significantly shorter than that in the Comparative Example (test piece 500), and the results showed that the Example had a lifetime that was six times as long as that of the Comparative Example regarding temperature stress.

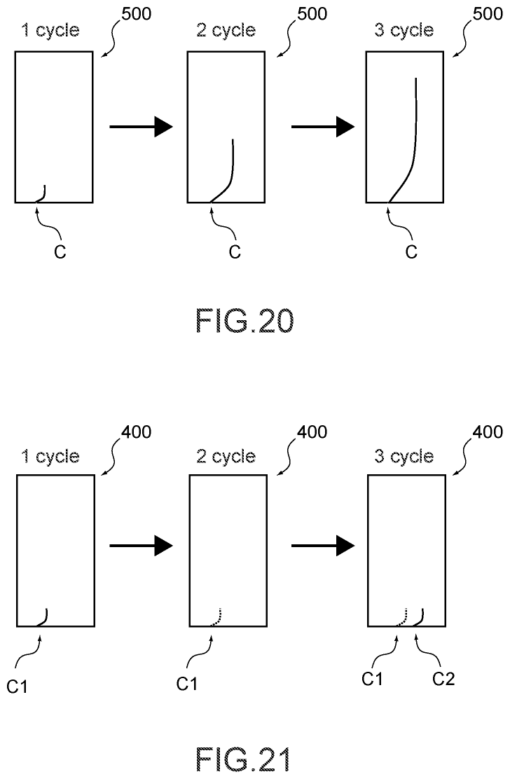

FIG. 20 is a schematic diagram showing observation results of cracks in the Comparative Example (test piece 500). As shown in the figure, when the crack C occurs in the test piece 500 due to temperature stress, the crack C expands and the cumulative length of the crack gradually increases as the number of cycles increases.

Meanwhile, FIG. 21 is a schematic diagram showing observation results of cracks in the Example (test piece 400). As shown in the figure, when a crack C1 occurs in the test piece 400 due to temperature stress, the crack C1 is healed by the self-healing action. After that, another crack C2 occurs at a position different from that of the crack C1 when temperature stress is applied. After that, the existing cracks do not expand and a new crack occurs similarly even if the number of cycles increases, and therefore, the increase in the cumulative length of caracks is suppressed. As a result, it is conceivable that the Example (test piece 400) had a significantly improved lifetime regarding temperature stress as shown in FIG. 19.

[Study on Adhesive Strength]

An experiment in which two sheets of glass were bonded by the self-healing material according to the present technology and the force required for tensile shearing of the self-healing material was measured was conducted. The self-healing material was a capsule in which a first capsule and a second capsule were mixed with a base material formed of an acrylic adhesive. The first capsule was a capsule that includes an outer shell formed of gelatin and an SGA main agent encapsulated in the outer shell, and the second capsule was a capsule that includes an outer shell formed of gelatin and an SGA curing agent encapsulated in the outer shell. The coating area of the self-healing material was 3 mm in diameter, and the total mixing amount of the first capsule and the second capsule was 20 wt % (weight percent concentration) with respect to the base material.

Further, for comparison, two sheets of glass were bonded with only a base material formed of an acrylic adhesive and the force required for tensile shearing of the self-healing material was measured. The coating area of the base material was 3 mm in diameter. The following [Table 3] is a table indicating the measurement results. As shown in [Table 3], the results that the self-healing material had an adhesive strength equivalent to that of the base material and the adhesive strength is not reduced by mixing the first capsule and the second capsule were obtained.

TABLE 3

| Sample | Only base | Self-healing |
|---|---|---|
| No. | material | material |
| 1 | 11.82 N/mm² | 11.98 N/mm² |
| 2 | 13.40 N/mm² | 12.26 N/mm² |
| Average | 12.61 N/mm² | 12.12 N/mm² |

[Study on Coatability]

An experiment in which 1 mg of the self-healing material according to the present technology was applied as one shot and the total weight of the applied self-healing material after 50 shots was measured was conducted. The self-healing material was a mixture of a first capsule and a second capsule in a base material formed of an acrylic adhesive. The first capsule was a capsule that includes an outer shell formed of gelatin and an SGA main agent encapsulated in the outer shell, and the second capsule was a capsule that includes an outer shell formed of gelatin and an SGA curing agent encapsulated in the outer shell. The total mixing amount of the first capsule and the second capsule was 20 wt % (weight percent concentration) with respect to the base material.

Further, for comparison, 1 mg of only a base material formed of an acrylic adhesive was applied as one shot and the total weight of the base material after 50 shots was measured. The following [Table 4] is a table indicating the measurement results. As shown in [Table 4], the results that the self-healing material had a coating weight equivalent to that of the base material and the coatability is not reduced by mixing the first capsule and the second capsule were obtained.

TABLE 4

| Sample | Only base | Self-healing |
|---|---|---|
| No. | material | material |
| 1 | 49.886 mg | 49.876 mg |
| 2 | 50.334 mg | 49.334 mg |
| Average | 50.110 mg | 49.605 mg |

(Regarding Present Disclosure)

The effects described in the present disclosure are merely examples and are not limited, and additional effects may be exerted. The description of the plurality of effects described above does not necessarily mean that these effects are exhibited simultaneously. It means that at least one of the effects described above can be achieved in accordance with conditions or the like, and there is a possibility that an effect that is not described in the present disclosure is exerted. Further, at least two feature portions of the feature portions described in the present disclosure may be arbitrarily combined with each other.

It should be noted that the present technology may also take the following configurations.
(1) A self-healing material, including:
   a base material;
   a first capsule that includes a first outer shell having flexibility and a first fluid encapsulated in the first outer shell, and is mixed with the base material; and
   a second capsule that includes a second outer shell having flexibility and a second fluid that is encapsulated in the second outer shell and to be cured by contact with the first material, and is mixed with the base material.
(2) The self-healing material according to (1) above, in which
   the first outer shell and the second outer shell are formed of a material having an elastic modulus of 20 MPa or more and 85 MPa or less.
(3) The self-healing material according to (1) or (2) above, in which
   the first outer shell and the second outer shell are formed of gelatin.
(4) The self-healing material according to (1) or (2) above, in which
   the first outer shell and the second outer shell are formed of melamine.
(5) The self-healing material according to any one of (1) to (4) above, in which
   the first fluid is an SGA (Second Generation Acrylic adhesive) main agent, and
   the second fluid is an SGA curing agent.
(6) The self-healing material according to any one of (1) to (5) above, in which
   the base material is joined to the first outer shell and the second outer shell.
(7) The self-healing material according to (6) above, in which
   the first outer shell and the second outer shell are formed of gelatin, and
   the base material is an epoxy adhesive or an acrylic adhesive.
(8) The self-healing material according to (6) above, in which
   the first outer shell and the second outer shell are formed of melamine, and
   the base material is an epoxy adhesive or an acrylic adhesive.
(9) The self-healing material according to any one of (1) to (8) above, in which
   the base material is a material having a Shore D hardness of 60 or more.
(10) The self-healing material according to any one of (1) to (9) above, in which
   a total mixing amount of the first capsule and the second capsule with the base material is 5% (V/V) or more and 20% (V/V) or less.

### REFERENCE SIGNS LIST

100 self-healing material
101 base material
102 first capsule
103 second capsule
121 first outer shell
122 first fluid
131 second outer shell
132 second fluid

1. A self-healing material, comprising:
a base material;
a first capsule that includes a first outer shell having flexibility and a first fluid encapsulated in the first outer shell, and is mixed with the base material; and
a second capsule that includes a second outer shell having flexibility and a second fluid that is encapsulated in the second outer shell and to be cured by contact with the first material, and is mixed with the base material.

2. The self-healing material according to claim 1, wherein
the first outer shell and the second outer shell are formed of a material having an elastic modulus of 20 MPa or more and 85 MPa or less.

3. The self-healing material according to claim 2, wherein
the first outer shell and the second outer shell are formed of gelatin.

4. The self-healing material according to claim 2, wherein
the first outer shell and the second outer shell are formed of melamine.

5. The self-healing material according to claim 1, wherein
the first fluid is an SGA (Second Generation Acrylic adhesive) main agent, and
the second fluid is an SGA curing agent.

6. The self-healing material according to claim 1, wherein
the base material is joined to the first outer shell and the second outer shell.

7. The self-healing material according to claim 6, wherein
the first outer shell and the second outer shell are formed of gelatin, and
the base material is an epoxy adhesive or an acrylic adhesive.

8. The self-healing material according to claim 6, wherein
the first outer shell and the second outer shell are formed of melamine, and
the base material is an epoxy adhesive or an acrylic adhesive.

9. The self-healing material according to claim 1, wherein
the base material is a material having a Shore D hardness of 60 or more.

10. The self-healing material according to claim 1, wherein
a total mixing amount of the first capsule and the second capsule with the base material is 5% (V/V) or more and 20% (V/V) or less.
